(19) United States
(12) Patent Application Publication
(10) Pub. No.: US 2005/0282119 A1
(43) Pub. Date: Dec. 22, 2005

(54) Method and apparatus for teaching life skills

(76) Inventor: Frederick A. Drayton SR., Washington, DC (US)

Correspondence Address: LAWRENCE HARBIN;MCINTYRE HARBIN & KING LLP, 500 9TH STREET, S.E., WASHINGTON, DC, 20003, US

(21) Appl. No.: 10/859,073

(22) Filed: Jun. 3, 2004

(51) Int. Cl. G09B 19/22

(52) U.S. Cl. 434/128

(57) ABSTRACT

An apparatus and method for teaching life skills is disclosed that includes a boss type selector, having a first boss type space representing a first management style and a second boss type space representing a second management style. Instructional cards are utilized in conjunction with the boss type selector to expose individuals to various types of management styles. An asset type selector is utilized in conjunction with the asset pieces to facilitate investing experiences. Counseling cards are utilized to familiarize individuals with various methods of coping with career related issues.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyrights whatsoever.

### FIELD OF THE INVENTION

The present invention relates generally to systems and methods of teaching life skills and/or preparing individuals for life-type experiences. More particularly, the present invention is directed to a board game designed for teaching and practicing management skills, goal setting, planning, strategizing, spending, saving, investing, and securities trading, as they relate to career and retirement planning.

### BACKGROUND OF THE INVENTION

Life skills, such as career and retirement planning, are often not in the curriculum of formal educational institutions. However, it is particularly important to teach such skills to teenagers who have not yet started their careers, and adults who have started their careers, but face many obstacles and decisions that have to be made regarding their career paths and retirement plans. Further, many individuals, once they begin their careers, are not prepared for the experiences they will encounter along the way, such as experiences with supervisors, also known as bosses.

There are a multitude of board games known in the prior art that involve players advancing from starting positions to ending positions along a path. Many of the prior art board games relate to fictitious circumstances and provide entertainment to the players.

However, with life's challenges, there is a need for tools that teach, as well as entertain. Specifically, there is a need to provide a tool for teaching life skills relating to career and retirement planning under non-life impacting conditions, i.e., where the decisions made during the experience do not impact one's future. Further, there is a need to provide a tool for allowing individuals to experience encounters with different types of bosses/supervisors, again under non life-impacting circumstances, where they can learn from such encounters and prepare for a time when they may have those types of experiences in their real lives.

Accordingly, it would be desirable to provide a method and apparatus for teaching and/or demonstrating life skills, in particular, skills relating to career and retirement planning, under non-life impacting circumstances.

Further, it would be desirable to provide a method and apparatus for exposing individuals to various types of supervisors that one may encounter during one's career.

### SUMMARY OF THE INVENTION

The present invention relates generally to systems and methods for teaching life skills and/or preparing individuals for life experiences.

In one aspect of the present invention, a game for teaching life skills is provided that includes, a boss type selector having a first boss type space representing a first management style and a second boss type space representing a second management style, a first set of instructional cards that correspond to the first boss space of the boss type selector, and a second set of instructional cards that correspond to the second boss space of the boss type selector.

In another aspect of the present invention, a game for teaching life skills is provided that includes a planar surface having a start position, a finish position, and a path extending between the start and finish position. The path has a portion that contains spaces that form at least part of the words “Boss Road™”.

In yet another aspect of the invention, a game for teaching life skills is provided that includes a boss type selecting means, having a first management style representation means, a second management style representation means, a first instructional means corresponding to the first management style representation means, a second instructional means corresponding to the second management style representation means.

In another aspect of the present invention, a method for teaching life skills is provided that includes, identifying a player to serve as a boss, identifying at least two players that follow instructions from the boss, and follow a course from school to retirement, while making investments, collecting bonuses, seeking counseling, and paying amounts of money to a financial institution, as they occur along the course.

Further, in another embodiment of the present invention, a method for teaching life skills is provided that includes, advancing between a start position and a finish position along a path. The path includes a portion having spaces that form at least part of the words “Boss Road”.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phrases and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out one or more of the purposes of the present invention. It is important, therefore, that the claims be regarded as including such equivalent constructions, insofar as they do not depart from the spirit and scope of the present invention.

### BRIEF DESCRIPTION OF THE DRAWINGS

FIG. 1 is a block diagram of a board game in accordance with the present invention.

FIG. 2 illustrates components of a board game in accordance with the present invention.

FIG. 3 illustrates “Boss” instructional cards in accordance with the present invention.

FIG. 4 illustrates “Professional Counseling” cards in accordance with the present invention.

FIG. 5 illustrates “Spiritual Counseling” cards in accordance with the present invention.

FIG. 6 illustrates “Grab Bag: Counsel from Coworkers at the Water Cooler” cards in accordance with the present invention.

FIG. 7 illustrates monetary assets, a debt indicator and a credit union share card in accordance with the present invention in accordance with the present invention.

FIG. 8 illustrates an evaluation report in accordance with the present invention.

FIG. 9 illustrates “Stock Exchange” cards in accordance with the present invention.

FIG. 10 illustrates a market value adjuster in accordance with the present invention.

FIG. 11 is a flow chart illustrating a method for teaching life skills.

### DETAILED DESCRIPTION OF THE PREFERRED EMBODIMENTS OF THE INVENTION

A system in accordance with the present invention exposes, teaches and/or allows individuals to experience certain encounters, for example, encounters that one may have between one's first job and retirement. In a preferred embodiment of the present invention, the system is a game that provides opportunities for individuals to experience, for example, management skills, goal setting, planning, strategizing, spending, saving, investing, and securities trading, particularly, as they relate to career and retirement planning.

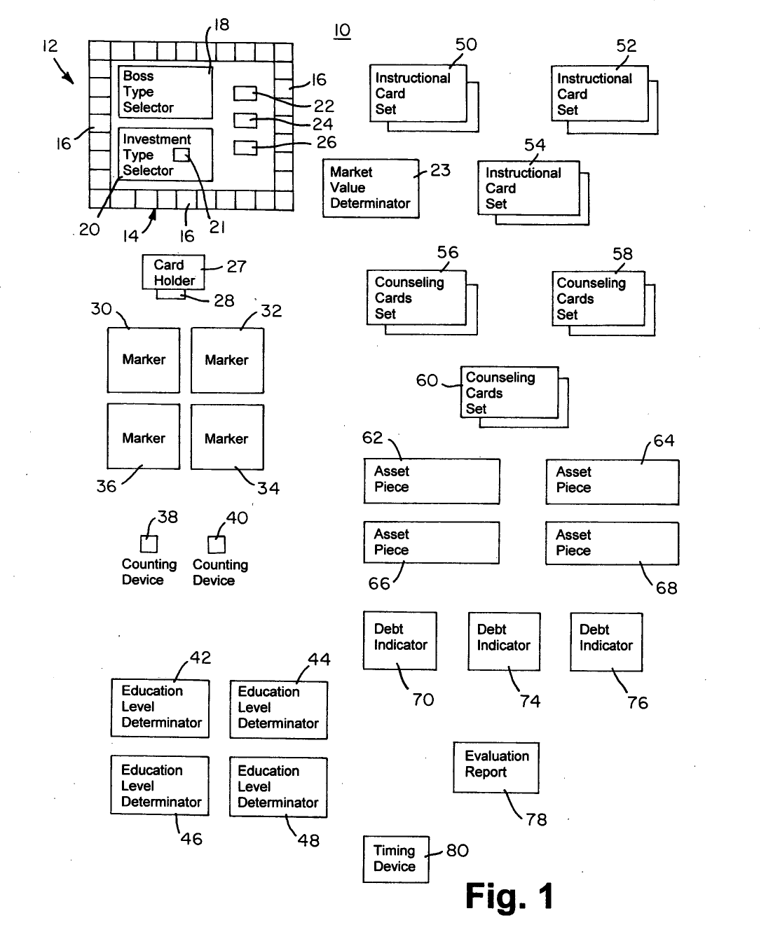

Referring now to the figures, there is shown, in FIG. 1, a system 10 in accordance with the present invention. In the preferred embodiment of the present invention, the system 10 is a board game that includes a board 12 having a path 14 of discrete spaces 16.

In the preferred embodiment of the present invention, the system 10 includes a boss type selector 18 and an investment/asset type selector 20. In an exemplary embodiment of the present invention, the investment type selector 20 includes or is coupled to a market value determinator 21. However, in the preferred embodiment of the present invention, a market value determinator 23 is separate from the investment type selector 20.

The market value determinator 21, 23 is utilized to demonstrate the volatile, e.g. bull or bear, nature of investments by determining what the value of an investment or investment portfolio is at the time of determination.

In the preferred embodiment of the present invention, there is at least one or more individual locations, 22, 24, 26 for positioning at least one card and/or set of cards. At least one card holder 27, having a lip 28 that accommodates a finger, is utilized for easy dispensing of cards from a set of cards.

In the preferred embodiment of the present invention, markers 30, 32, 34, 36 are utilized to represent the players that move around the path 14. The markers 30, 32, 34, 36 are in the form of objects, for example, school houses that vary in color, allowing each player to readily identify his marker 30, 32, 34, 36.

One or more counting devices 38, 40 are utilized to determine the number of spaces 16 a player advances around the path 14. In the preferred embodiment of the present invention, two counting devices, a first die and a second die that form a pair of dice, are utilized in determining the number of spaces 16 a player advances around the path 14.

Education level determinators 42, 44, 46, 48, include, for example, a determinator representing: 1) a high school level of education; 2) a college level of education; 3) a master's level of education; and 4) a doctorate level of education. In the preferred embodiment of the present invention, each of the education level determinators 42, 44, 46, 48 are represented by a card.

At least one set of instructional cards 50, 52, 54 is utilized to facilitate experiences with various types of management styles. A set of cards, in the preferred embodiment of the present invention, includes at least two cards which may be arranged in a stack/deck. In the preferred embodiment of the present invention, there are three sets of instructional cards 50, 52, 54, referred to as “Boss's Office” cards

At least one set of counseling cards 56, 58, 60 is utilized to provide suggestions, advice and/or counseling. In the preferred embodiment of the present invention, there are three sets of counseling cards 56, 58, 60. A first set of counseling cards 56 is referred to as “Spiritual Counseling” cards. A second set of counseling cards 58 is referred to as “Professional Counseling” cards. A third set of counseling cards 60 is referred to as “Grab Bag: Counsel from Co-workers at the Water Cooler” counseling cards.

Asset pieces 62, 64, 66, 68 are utilized to represent various assets, for example, money, savings, and various forms of investments. In the preferred embodiment of the present invention, individual pieces of paper, marked with values from and including, for example, one hundred dollars ($100) to twenty thousand dollars ($20,000) are utilized to represent cash/money, i.e. monetary assets. Cards are utilized to represent amounts of savings, for example, Credit Union shares, and tokens, for example, colored metallic and/or metallic-like devices, are utilized to represent investment shares.

Debt indicators 70, 72, 74 are utilized to represent, for example, loans from a financial institution, for example, Credit Union. In the preferred embodiment of the present invention, cards are utilized to represent a debt owed and/or an interest rate associated with the debt.

In an exemplary embodiment of the present invention, an evaluation report 78 is utilized to track, for example, a player's investments, cash in-hand, debts, and/or savings.

A timing device 80 is utilized, in an exemplary embodiment of the present invention, to track a length of time a player or team has been utilizing the system 10, for example, during a playing of a board game in accordance with the present invention. In the preferred embodiment of the present invention, a timer is utilized to determine how long an individual player and/or team of players has been playing a game in accordance with the present invention. However, other timing devices 80 may be utilized, for example, a clock or a two-part glass device, such as an hour-glass type device, which is filled with a material, for example sand, and used to measure an amount of time.

It will be understood by one of ordinary skill in the art that the components associated with a board game in accordance with the present invention may vary, in size, shape and form. In addition, components, for example, selectors, 18, 20, and the at least one card holder 27, may be coupled to the board 12, formed continuously with the board 12, and/or exist separately from the board 12.

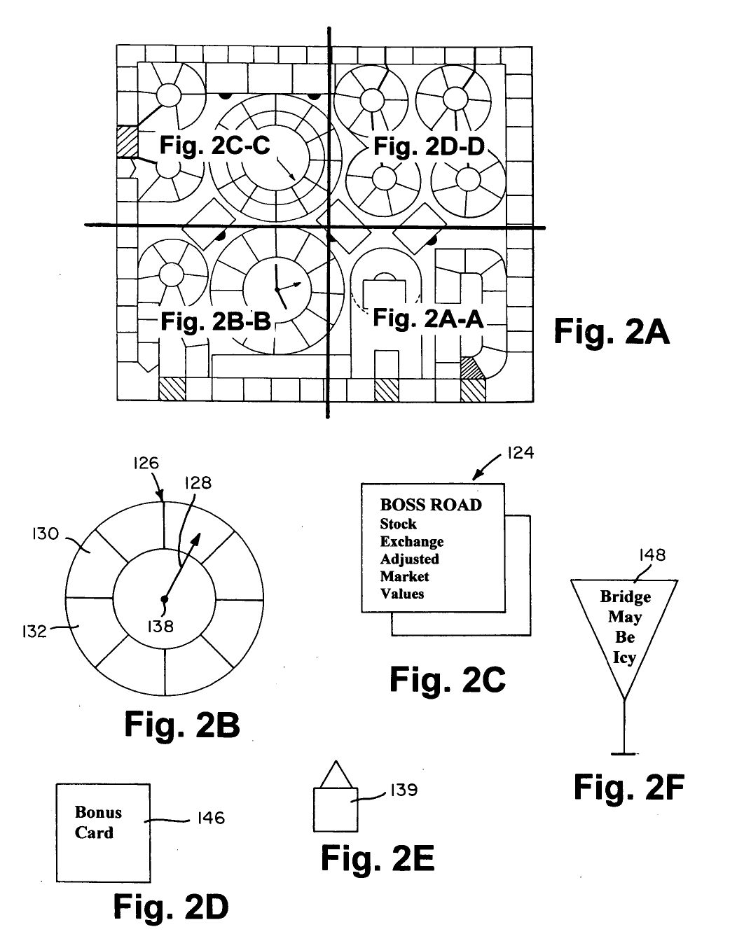

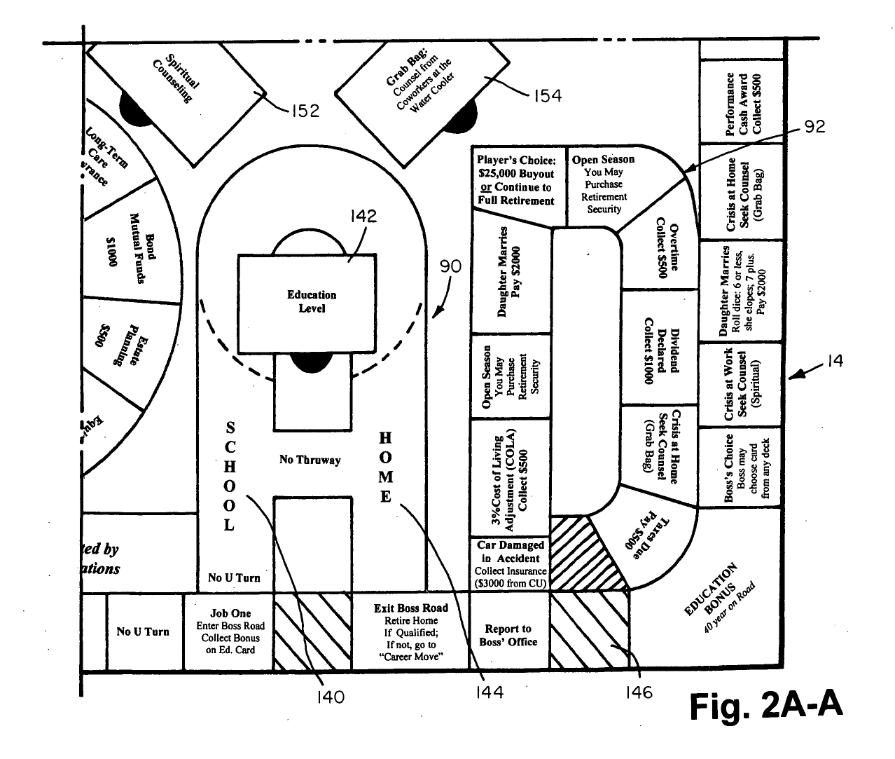

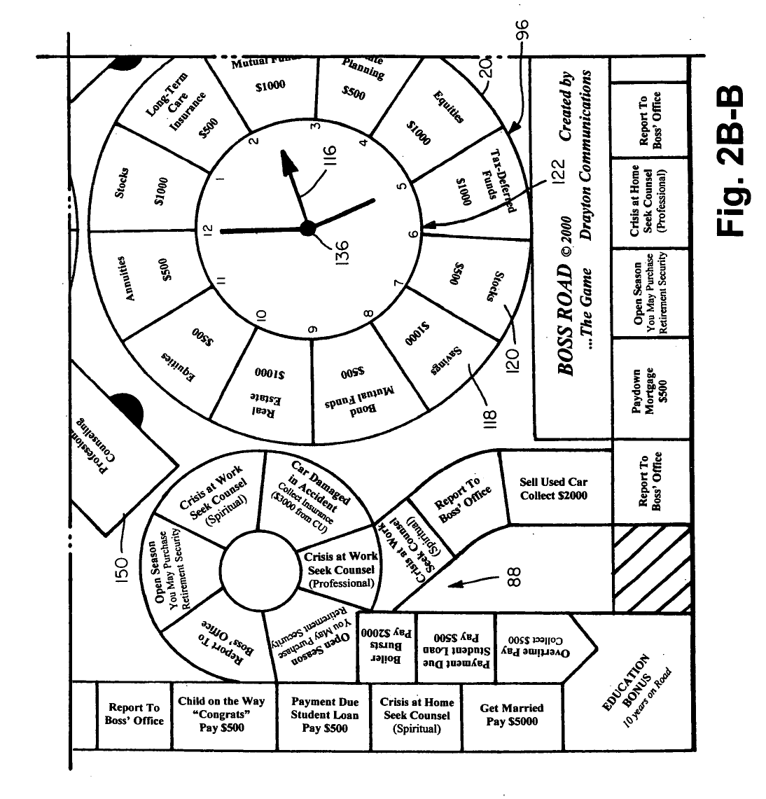

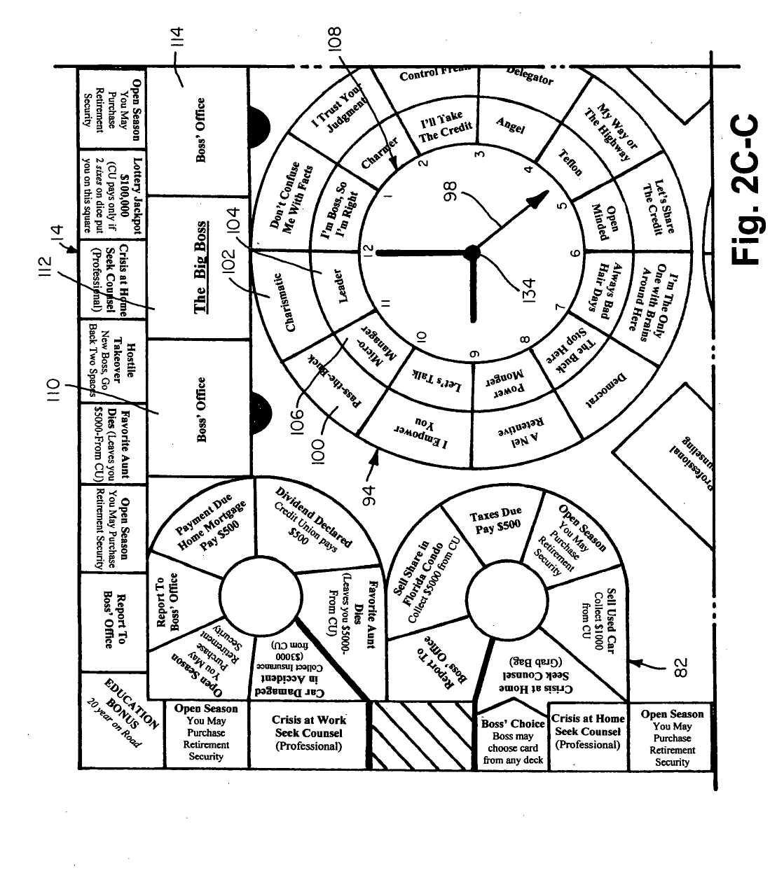

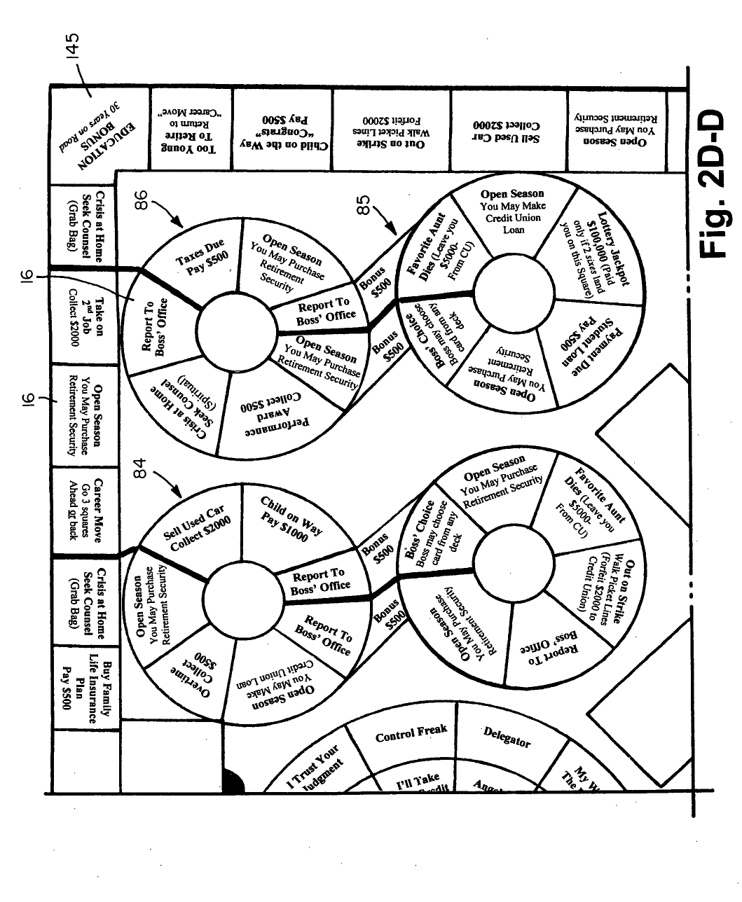

Shown in FIG. 2 is a board 12 in accordance with a preferred embodiment of the present invention. In the preferred embodiment of the present invention, some of the discrete spaces 16 are formed into the words “Boss Road”. In an exemplary embodiment of the present invention, the board 12 is rectangular, planar and foldable. It should be understood by one of ordinary skill in the art that the construction of the board 12 may vary.

In the preferred embodiment of the present invention, the board 12 includes spaces 16, which players utilize to move around the path 14, that are positioned around a peripheral of the board 12, as well as spaces 16, which, are arranged in shapes and/or forms representing a “B” 82, a first “S” 84, a second “S” 86, an “R” 88, an “A” 90, and a “D” of the words that spell “BOSS ROAD”.

The portions of the Board 12 representing the letters “O” 94 in the word “BOSS” and the “O” 96 in the word “ROAD” are positions on the board 12 that include a first selector device 18 and a second selector device 20. In the preferred embodiment of the present invention, the letter “O” 94 in the word “BOSS” includes a boss type selector 18, and the letter “O” 96 in the word “ROAD” includes an investment type selector 20.

In the preferred embodiment of the present invention, the boss type selector device 18 is a spinning device that includes an indicator 98, for example, a pointer, such that after the indicator 98 is spun, it points in the direction of a boss type space and/or category.

In the preferred embodiment of the present invention, the boss type selector 18 has outer perimeter spaces, for example spaces 100, 102, and corresponding inner perimeter spaces positioned below the outer perimeter spaces, for example spaces 104, 106, which are printed directly on the board and coded, at least in part, with a color. In an exemplary embodiment of the present invention, an outer perimeter space and an inner perimeter space form a pair, for example, space pairs 100, 104 and 102, 106.

In the preferred embodiment of the present invention, a clock 108 indicating nine o'clock is for example, pre-printed on the board 12 in the “O” 94 section of the board 12.

In the preferred embodiment of the present invention, the outer and inner spaces include boss type and/or management style indicia, for example: 1) “I'll Take the Credit”; 2) “Power Monger”; 3) “Teflon”; 4) “Pass the Buck”; 5) “I'm the Only One with Brains Around Here”; 6) “My Way or the Highway”; 7) “Control Freak”; 8) “Don't Confuse Me with Facts”; 9) “I'm Boss, I'm Right”; 10) “Micro-manager Manager”; 11) “Anal Retentive”; 12) “Be My Friend”; 13) “Charmer”; 14) “The Buck Stops Here”; 15) “Goodfella”; 16) “What Do You Think”; 17) “How Much Time Do You Need”; 18) “Angel”; 19) “Perpetual Good Hair Days”; 20) “Delagator”; 21) “Leader”; 22) “Charismatic”; and 23) “Captain Courageous”.

When a player lands on a space, for example, a “Report to Boss's Office” space along the path 14, which prompts the Boss to utilize the boss type selector 18, and thus activate an indicator 98 of the boss type selector 18, the Boss will select a card from a set of instructional cards that correspond to the color of the boss type space directed to by the indicator 98.

In the preferred embodiment of the present invention, a first instructional card space 110 is provided for a first set of instructional cards 50 coded with a first color, a second instructional card space 112 is provided for a second set of instructional cards 52 coded with a second color, and a third instructional card space 114 is provided for a third set of instructional cards 54 coded with a third color. In the preferred embodiment of the present invention, each of the first, second, and third sets of instructional cards 50, 52, 54 are of different color from the others.

In the preferred embodiment of the present invention, an asset type selector 20 includes an indicator 116, and has spaces positioned around the perimeter, for example, spaces 118, 120. In the preferred embodiment of the present invention, the spaces include asset/investment type indicia representing, for example: 1) High Yield Securities; 2) Emerging Market Funds; 3) Long Term Bond Funds; 4) Certificates of Deposit; 5) Foreign Securities; 6) Corporate Bond Funds; 7) Preferred Stocks; 8) U.S. Savings Bonds; 9) Treasury Bills; 10) Common Stocks; 11) Individual Retirement Accounts; 12) Credit Union Shares; 13) Keogh, 14) Thrift Savings Plans; 15) Mutual Funds; 16) Money Market Funds; 17) Short Term Bonds; 18) Debenture Bonds; 19) Municipal Bonds; 20) Real Estate 21) Futures; 22) 401(k); 23) International Equity Funds; and 24) Aggregate Growth Funds.

In the preferred embodiment of the present invention, asset type selector 20 includes spaces, for example, spaces 118, 120 that are coded with a color and marked with the one of the following asset type indicia: 1) “Stocks”; 2)“Long Care Term Care Insurance”; 3)“Bond Mutual Funds”; 4)“Estate Planning”; 5) Equities; 6) “Tax Deferred Funds”; 7)“Savings”; 8) “Real Estate”; and 9) “Annuities”. The various types of assets are grouped, and each group of assets is identifiable by a color that is different from a color representing another group of assets. In the preferred embodiment of the present invention, there are six asset groups that contain one or more asset types.

When a player lands on a space, for example, an “Open Season You may purchase Retirement Security” space along the path 14, which prompts the Boss to activate an indicator 116 of the asset type selector 20, the player may purchase the type of retirement security pointed to by the indicator 116, after it has been spun by the player or Boss.

In another exemplary embodiment of the present invention, each of the spaces, such as spaces 118, 120, around the perimeter of the asset type selector 20 are coded with a color that represents a category of assets from which a player may purchase. As a result, a player may purchase any asset that is coded with the same color of the space of the asset type selector 20 that is pointed to by the indicator 116, after it has been spun.

If the indicator stops between two differing assets or asset color categories, then the player or Boss may choose between the two differing assets or asset color categories from which the player will purchase an asset. The unit cost of each asset type is printed on the respective asset spaces, for example, spaces 118, 120.

In the preferred embodiment of the present invention, a clock 122 indicating five o'clock is, for example, pre-printed on the board 12 in the “O” 96 section of the board 12. As a result the “O” 94 and the “O” 96 represent nine o'clock and five o'clock, which, respectively, represent the beginning and end of a work day.

In the preferred embodiment of the present invention, a market value determinator 23 is provided that is external to the board 12 that determines an adjusted value of each asset of a player's portfolio. In the preferred embodiment of the present invention, the market value determinator is a set of cards 124 referred to as “Stock Exchange” cards that indicate by how much values for an asset have increased, for example, by gaining value as a result of a “bull” market, or decreased, for example, as a result of a “bear” market.

In the preferred embodiment each asset type or asset category is coded with a color and the “Stock Exchange” cards indicate an adjusted asset value amount for each asset color. In an exemplary embodiment of the present invention, the adjusted asset value amount is a percentage by which to reduce or increase the value of an asset.

In yet another exemplary embodiment of the present invention, an asset type selector 20 includes and/or is coupled to the market value determinator 21.

In the preferred embodiment of the present invention, indicia of the selector devices 18, 20 are printed on the board 12, and the indicators 98, 116 are coupled to the board 12 via a coupler 134, 136, for example, a fastener. Similarly, the indicator 128 of selector 126 is coupled to a base 127 of the selector 126 via a coupler 138. It should be understood by one of ordinary skill in the art that the type of coupler 134, 136, 138 utilized for each selector device 18, 20, 126 may vary. In another exemplary embodiment of the present invention, the selector devices 18, 20, 126 are separate from the board 12, and during a playing of the game are positioned in spaces representing the “O” 94 in the word “BOSS”, and the “O” 96 in the word “ROAD”.

In the preferred embodiment of the present invention, the path 14 of the board 12 represents a player's journey from his first job, i.e., “job one” to “retirement”, i.e. when one can stay at home and not have to work. At the start of the game each player places his marker 139 in the starting section 140 of the board 12, which in the preferred embodiment of the present invention is referred to as the “SCHOOL” section of the board 12.

At the start of the game each player also selects an education level determinator 42, 44, 46, 48 from a stack of education level determinators placed in the education level space 142 of the board 12. The education level determinators 42, 44, 46, 48 represent the level of education and/or number of years of school the player is determined to have completed prior to the start of the game. In the preferred embodiment of the present invention, before a player leaves the start section 140, each player is given a free public education via a high school education level determinator card that is passed out by the Boss from the stack of education level determinators 42, 44, 46, 48 positioned at the education level space 142.

The finishing section 144 of the board 12, which in the preferred embodiment of the present invention, is referred to as the “HOME” section of the board 12, and is where a player returns when he has successfully met one or more predetermined conditions for retirement, and/or is considered a winner of a game in accordance with the present invention. In the preferred embodiment of the present invention, the finish section 144 of the board 12 is where a player returns when he has successfully rolled the dice to advance his marker/game piece 139 to that point on the board 12. If all other criteria have been met for retirement, that player is considered a winner of the game in accordance with the present invention.

Between the starting section 140 of the board 12 and the finishing section 144 of the board 12 are discrete spaces 16. In an exemplary embodiment of the present invention, the path 14 includes active spaces that require some action by a player when he lands on the active space. Further, some of the active spaces 16 are repeated on the path 14. In another exemplary embodiment of the present invention, the board 12 includes non-active spaces 16 that do not require any action by a player when he lands on the space. In an exemplary embodiment of the present invention, each space landed on by a player is an active space.

For example, in the preferred embodiment of the present invention, each of the four corners of the board 12 includes a quarterly bonus space or education bonus space, such that when a player lands on one of the corner spaces, for example, space 145, he will receive a bonus.

In the preferred embodiment of the present invention, the amount of the bonus is in accordance with the order of the corner spaces from the beginning of the path 14. Accordingly, 1) when a player lands on a first corner space, he receives a bonus of one times (1×) the dollar amount printed on his present education level determinator 42, 44, 46, 48; 2) when a player lands on the second corner space, he receives a bonus of two times (2×) the dollar amount printed on his present education level determinator 42, 44, 46, 48; 3) when a player lands on a third corner space, he receives a bonus of three times (3×) the dollar amount printed on his present education level determinator 42, 44, 46, 48; and 4) when a player lands on a fourth corner space, he receives a bonus of four times (4×) the dollar amount printed on his present education level determinator 42, 44, 46, 48. In another exemplary embodiment of the present invention, a bonus factor and/or amount is printed on, for example, an education level determinator card.

In another exemplary embodiment of the present invention, when a player lands on one of the corner spaces, for example, space 145, he will receive a thousand dollars ($1000) for each year of education he has attained according to an education level determinator 42, 44, 46, 48.

“Open Season You May Make a Credit Union Loan” is an example of a space of another exemplary embodiment of the present invention. When a player lands on this space the player takes out a loan from a financial institution, which in the preferred embodiment of the present invention is referred to as the “Credit Union”, in increments of two thousand five hundred dollars ($2500).

“Open Season You May Purchase Retirement Security” is an example of space that is repeated on the path 14. When a player lands on this space, the player is allowed to purchase retirement securities according to the investment type selector 20.

Report to Boss's Office is another example of a space that is repeated on the path 14. When a player lands on a space instructing him to report to the Boss's Office, the Boss spins the indicator of the boss type selector 18 to determine the mood and/or management style of the boss.

The boss type spaces, for example spaces 100, 102, 104, 106 around the periphery of the wheel determine a mood/style of the Boss. In the preferred embodiment of the present invention, the spaces include indicia of exemplary management styles, and are coded, for example, by a coloring of the space, in one of two colors. In the preferred embodiment of the present invention, the two colors of boss type spaces are red and blue and representative of the mood, personality, and or style of boss.

Accordingly, the Boss selects a card from a colored stack of instructional cards 50, 52, 54 that match the color of the boss type space, which is indicated by the indicator 98 of the boss type selector 18, to instruct the player.

In the preferred embodiment of the present invention, the blue set of cards represent good and/or nice bosses and the red set of cards represent bad and/or not so nice bosses. In the preferred embodiment of the present invention, there is also a white set of cards, indicative of the “Big Boss”, that represents personality types of bosses varying from, for example, a good/nice boss type to bad/not so nice boss type or a combination of both.

The Boss selects from the “Big Boss” cards when the indicator stops on the line between two boss type spaces, for example, spaces 102, 106. It should be understood by one of ordinary skill in the art the number of sets of instructional cards 50, 52, 54 representing boss types and/or the color of the sets of cards may vary in other exemplary embodiments of the present invention. In another exemplary embodiment of the present invention, the player selects from the instructional card sets 50, 52, 54.

After the Boss selects an instructional card, the Boss reads the selected card aloud, and the player follows the instructions read from the card by the Boss. The card will, for example, require the player to collect money, pay money, move ahead a number of spaces 16 which may be predetermined, and/or move backwards a number of spaces 16 which may be predetermined.

In an exemplary embodiment of the present invention, each of the “Big Boss” set of cards will either: 1) offer a player a choice of either collecting money or moving ahead a number of spaces 16 which may be predetermined; or 2) paying money or moving backwards a number of spaces 16 which may be predetermined. After a card is read, the card is put to the side for reshuffling when the stack has been exhausted and/or the game is finished.

“Dividend Declared” is another example of a space that is repeated on the path 14. When a player lands on a space declaring a dividend, the player is paid five hundred to one thousand dollars ($500- $1000) by the Credit Union for each Credit Union share he owns.

“Favorite Aunt Dies” is another example of a space that is repeated on the path 14. When a player lands on this space, the Credit Union pays five thousand ($5000) to the player.

“Out on Strike” is another example of a space that is repeated on the path 14. When a player lands on the “Out on Strike” space, the player is considered to be walking the picket lines and forfeits two thousand dollars ($2000) to the Credit Union.

“Child on the Way”, is yet another example of a space that is repeated on the path 14. When the player lands on the “Child on the Way” space, the player is congratulated and is required to pay an amount indicated on the space to the Credit Union.

In another exemplary embodiment of the present invention, when the player lands on the “Child on the Way” space, the player is congratulated and is instructed to roll a die. The player then multiplies the number of the die times one hundred (100). The resulting amount corresponds to the cost of the child, and the player is required to pay that amount to the Credit Union.

“Daughter Marries” is another example of a space that is repeated on the path 14. When the player lands on the “Daughter Marries” space, the player rolls the dice. If the combined amount on the dice is six (6) or less, the daughter is considered to have eloped, and the player is not required to pay any amount to the Credit Union. If the combined amount on the dice is more than six (6), then the player pays one thousand ($1000) times the amount on the dice to the Credit Union, and that is considered to be a cost of the wedding.

“Overtime Pay” is another example of a space that is repeated on the path 14. When the player lands on the “Overtime Pay” space, the player collects the amount indicated on the space from the Credit Union. In another exemplary embodiment of the present invention, when a player lands on the “Overtime Pay” space, the player rolls the dice and gets fifty (50) times the amount on the dice from the Credit Union.

“Lottery Jackpot” is another example of a space that is on the path 14. When a player lands on the “Lottery Jackpot” space, the Credit Union pays the player one hundred thousand dollars ($100,000.00) only if the roll of, for example, two sixes (6's) on the dice landed the player on the “Lottery Jackpot” space.

Other active spaces 16 along the path 14 of the board 12 include: 1) “Pay Union Dues”, which instructs the player to pay amount indicated on the space; 2) “Get Married, Best Wishes”, which instructs the player pay five thousand dollars ($5000), and in another exemplary embodiment, to roll the dice and pay one hundred (100) times the amount on the dice to the Credit Union; 3) “Payment Due Student Loan”, in which the player is instructed to roll the dice and pay five hundred dollars ($500), and in another exemplary embodiment, to pay fifty (50) times the amount on the dice to the Credit Union; 4) “Hostile Takeover”, which instructs the player that they have a new boss and to go back two spaces; and 5) “Companies Merge”, which instructs the player that he has a new boss and to roll again.

Further, in a preferred embodiment of the present invention, there are other active spaces, for example: 1) “Payment Due Home Mortgage”, which instructs the player to pay five hundred dollars ($500) to the Credit Union, an in another exemplary embodiment of the present invention, to roll the dice and pay fifty (50) times the amount on the dice to the Credit Union; 2) “Sell Used Car”, in which the player is instructed to collect one thousand dollars $1000 from the Credit Union; 3) “Sell Share in Florida Condo”, which instructs the player to collect five thousand dollars $5000 from the Credit Union; 4) “Taxes Due”, in which the player is instructed to pay five hundred dollars ($500) to the Credit Union, and in another exemplary embodiment of the present invention, to roll the dice and pay fifty (50) times the amount on the dice to the Credit Union; 5) “Payment Due Credit Union Loan”, which instructs the player to roll the dice and pay fifty (50) times the amount on the dice to the Credit Union; 6) “Car Damaged in Accident”, in which the player collects three thousand dollars ($3000) from the Credit Union; 7) “Three Percent Cost of Living Adjustment”, in which the player receives five hundred dollars ($500) from the Credit Union, and in another exemplary embodiment, the player is instructed to roll one die and receive thirty (30) times the amount on the die from the Credit Union; 8) “Taxes Due”, which instructs the player to pay five hundred dollars ($500) to the Credit Union, and in another exemplary embodiment, instructs the player to roll the dice and pay fifty (50) times the amount on the dice to the Credit Union.

In an exemplary embodiment of the present invention, the counting devices 38, 40 are only utilized to determine which player will be the first player to begin advancing around the board 12, and during a playing of the game when it is a player's turn to move his marker 30, 32, 34, 36 around the board 12. Accordingly, any amounts paid to the Credit Union or received from the Credit Union do not involve use of a die or dice, and are predetermined and according to an amount printed on a card and/or a space.

In the preferred embodiment of the present invention, there are filler zones, for example, space 146. The filler zones assist in navigating/directing a player along the path 14, such that the player knows which space to move to next as he proceeds along the path 14. Accordingly, when avoiding a filler zone, the player travels properly along the path 14 and lands on the next succeeding space, e.g., non-filler zone and/or active space.

The filler zones may be marked by: 1) a printed written description and/or sign; and/or 2) a printed filler, for example, making the space a solid color or filling the space with hashed lines.

In an exemplary, embodiment of the present invention, other spaces 16 along the path 14 include, for example: 1) “Congratulations, Retire in Thirty Years”; 2)“No U Turn”; 3) “Follow at a Safe Distance”; “Caution: Men at Work”; 4) “Bridge May be Icy”; 5) “Construction Bypass”, 6) “Steel Plates in Roadway”; 7) “Take Second Job; 8) “Pot Holes”; and 9) “Unsettled Pavement”.

The spaces may be marked by: 1) a printed written description and/or sign; 2) a printed filler, for example a solid color or hashed lines; and/or 3) an external marker 148 that represents the space. For example, in an exemplary embodiment of the present invention, a marker 148 that appears as an icy bridge replica or a sign that names the space, for example a sign that reads “Bridge May Be Icy” may be placed in a space or a filler zone on the board.

Three counseling card spaces 150, 152, 154 are provided for a first set of counseling cards, a second set of counseling cards and a third set of counseling cards. A first set of counseling cards is referred to as “Spiritual Counseling” cards. A second set of counseling cards is referred to as “Professional Counseling” cards. A third set of counseling cards are referred to as Grab Bag: Counsel from Co-workers at the Water Cooler” counseling cards.

When a player lands on a space and/or receives instruction to seek counseling, for example when a player lands on a “Crisis at Work” or “Crisis at Home” space, the player is considered to be under stress and must seek the type of counseling associated with the space. Accordingly, the Boss selects a card from the top of either the “Professional Counseling” stack of cards, the “Spiritual Counseling” stack of cards, or the “Grab Bag: Counseling from Co-workers at the Water Cooler” stack of cards. In another exemplary embodiment of the present invention, the player selects the counseling card.

In the preferred embodiment of the present invention, counseling is a private matter. Accordingly, the counseling card is not read aloud, and only the player sees the card.

An objective of a game in accordance with the present invention is to be the first player to travel the path and return to the finish section, i.e. return home, after, for example,: 1) repaying all Credit Union debts, if any, at ten percent (10%) interest; 2) purchasing and saving at least twenty-five thousand dollars ($25,000) in Credit Union shares; and 3) acquiring a diversified portfolio totaling at least five thousand dollars ($5000).

A diversified portfolio, according to the preferred embodiment of the present invention, is a portfolio consisting of at least one (1) share from four of six asset categories. In the preferred embodiment of the present invention, each of the asset categories is represented by a different color.

A board game in accordance with the invention is played, for example, according to the following rules. One of the participants serves as a boss/supervisor by volunteering to be the “Boss”. In another exemplary embodiment of the present invention, the Boss is selected according to who utilizes one or more counting devices 38, 40, by, for example, rolling the die or dice, and getting either the highest number or lowest number.

The Boss does “boss-type” work, for example, shuffling stacks of cards, dispensing cash, brokering loans, reading and dispensing instructional cards, which in an exemplary embodiment of the present invention, are labeled as “Boss's Office” cards, verifying and signing evaluation reports 78, and making decisions when there are player questions regarding the interpretation of the rules of the game. The Boss is also responsible for preserving the integrity of the game and its operations, i.e., ensuring that a game is played in accordance with the rules, and making decisions about how the game should be played when the rules are unclear. In the preferred embodiment of the present invention, the Boss is not represented by a marker 30, 32, 34, 36 and does not move around the path 14 with the other players.

Prior to the start of the path 14, each player that moves around the path 14 selects a marker 30, 32, 34, 36, and places his marker 30, 32, 34, 36 in a start section 140 of the board 12 which, in the preferred embodiment of the present invention, is labeled as the home section of the board 12. Each player utilizes a counting device 38, 40, for example, a die or pair of dice, by rolling the die or dice to determine which player moves first.

The player with the highest or lowest amount indicated by the counting device 38, 40 moves first, followed in succession by each player to the left. In another exemplary embodiment of the present invention, the first player is followed in succession by each player to the right. It should be understood by one of ordinary skill in the art the order by which the players take their turn may be arbitrary.

Before a player leaves the start section, each player is given a free public education via a high school education level determinator card that is passed out by the Boss. The education level determinators 42, 44, 46, 48 are particularly significant when a player lands on a “Report to Boss's Office” space, as the Boss may draw a card, from one of the instructional sets of cards 50, 52, 54, for example, from one of the boss type sets of cards, that may award a cash bonus to a player according to his education level. The education level determinators 42, 44, 46, 48 are also significant when a player lands on an Education Bonus space.

In another exemplary embodiment of the present invention, each player selects an education level determinator 42, 44, 46, 48 from a set of education level determinator cards 42, 44, 46, 48 to determine the education level at which the player is assumed to have achieved prior to beginning of his trip around the path 14, which in the preferred embodiment of the present invention is referred to as “Boss Road”.

Once on the game path 14, a player, at each of his turns, has the option to improve his education, and thus, possibly increase his bonus potential. If a player decides that he wants an opportunity to increase his education level, the player, in an exemplary embodiment of the present invention: 1) informs the boss of his intention to seek a higher education level; 2) forfeits his opportunity to roll the dice on his turn; and 3) purchases, from the Boss, an education level determinator 42, 44, 46, 48 at the next higher education level from the education level presently held by the player and having a price that is preprinted on the education level determinator 42, 44, 46, 48; and 4) plays the game at the higher education level until he chooses, at another turn, to increase his education to the next higher education level. A player may not always advance along the path 14 at each turn, as there are spaces 16 and/or cards which may require the player to move backwards along the path 14.

After the first player has been determined, each player, in succession, rolls the dice to start moving along the path 14. On a first roll, each player passes over an initial funding space, which in the preferred embodiment of the present invention, entitles the player to collect, from the Boss, an initial cash bonus in the amount printed on his “education level” card. The initial cash bonus serves as seed money for the beginning of the trip around the path 14, and is utilized by each player to pay assessments and purchase assets until additional financial resources are acquired during a playing of the game.

After each player moves pass the initial funding space, which in a preferred embodiment of the present invention is referred to as the “Job One” space, the player moves around the path 14 towards retirement, i.e. home. After the initial roll of the dice, each player, at his turn, moves around the path 14 according to the total number indicated by the counting device or devices utilized 38, 40, for example, the total number represented during a throw of the die/dice, unless the player, according to the rules of the game has forfeited his opportunity to roll the die/dice.

After a player has moved the total number of spaces 16, in accordance with the number represented by the counting device or devices 38, 40, the player responds, if required, in accordance with the space on which he lands. If the player lands on an active space, for example, one of the active spaces 16 described above, the player responds in accordance with the instructions associated with the active space itself and/or a card resulting from landing on the space.

If a player lands on a space or receives a card that requires the player to move backwards, the player does not subsequently follow any instructions associated with the space on which he lands after moving backwards.

In the preferred embodiment of the present invention, the player who wins the game is the player who is the first to travel from school and return home after: 1) repaying all Credit Union debts, if any, at ten percent (10%) interest; purchasing and saving at least twenty-five thousand dollars ($25,000) in Credit Union shares; and 3) acquiring a diversified portfolio totaling at least five thousand dollars ($5000).

In a second embodiment of the present invention, a multiple number of games are played before a winner is determined. In the multiple-game format, the players agree upon a predetermined number of games, which form a series of games, that will be played. Each game of the series of games is played in accordance with the preferred embodiment of the present invention.

The Boss should vary for each game of the multiple number of games if possible. The predetermined number of games may correspond to the number of games that will allow each player to be the Boss, at least once. An evaluation report 78 is utilized to maintain a record of a player's performance during each game played. An evaluation report includes space to track a player's assets, loans, savings, and debt repayment history.

After the predetermined number of games have been played, the evaluation reports 78 are reviewed to determine a winner of the series of games. The player who has, for example,: 1) won at least one game of the predetermined number of games; 2) saved the largest aggregated amount of capital in the Credit Union shares; 3) acquired assets, for example, retirement-related assets with the largest total face value; and 4) repaid all Credit Union loans at ten percent (10%) interest in each game of the series is the winner of the series of games games.

In a third exemplary embodiment of the present invention, a group of individuals play the game as a team against a timing device 80, for example, a clock. During a game in accordance with the third exemplary embodiment of the present invention, each of the individual members of the team receives a marker 30, 32, 34, 36 to travel around the path 14.

While a game of the third exemplary embodiment is played in accordance with the preferred embodiment of the present invention, the object of the game differs in that the goal of a game of the third exemplary embodiment is for each of the team members to individually reach retirement within the predetermined amount of time, for example, sixty (60) minutes if there are two (2) team members, or ninety (90) minutes if there are three (3) team members. In the preferred embodiment of the present invention, a team includes at least three participants.

Of the participants, one serves as the Boss and does not move around the path 14 as the other players. The Boss may be selected by the team members, and serves as the leader, controller, motivator, and manager of the team, and participates with the players in for example, setting goals, preparing a budget, planning and implementing a strategy and managing time.

For example, before a game begins, the Boss, along with the team members, agree upon a budget that the team believes will allow each of the team members to be successful at retiring before the predetermined amount of time expires. The amount agreed upon is available for use by each of the team members throughout the game.

The Boss also delegates responsibilities to team members, with or without input from the other team members, for example, who will make investment decisions and which member will go to the Boss's Office when a player lands on a “Report to Boss's Office” space. In the team format, the player who lands on a “Report to Boss's Office” space does not have to be the actual player who reports to the Boss's Office. The Boss and/or the team strategically decide which player, in the interest of the team, reports to the Boss's Office, i.e., has to respond to the Boss Card.

The Boss, with or without input from the team members, also delegates authority to other team members who will authorize cash transactions and/or make certain financial decisions for each of the team members. For example, one team member will have the authority to decide when one of the team members can make a loan and/or when a team member can make educational level decisions, independent of whether the team member has requested permission to conduct such act. When a loan is allowed to be made, in an exemplary embodiment of the present invention, it is made in increments of two thousand five hundred dollars ($2500).

Moreover, the Boss is also responsible for preserving the integrity of the game and its operations, i.e., ensuring that a game is played in accordance with the rules, and making decisions about how the game should be played when the rules are unclear.

A team is considered to be successful in a game against the clock, and thus, a winning team or group of players, when each player of a team has retired before the predetermined amount of time expires, i.e. has traveled from school to home after: 1) repaying all Credit Union debts, if any, at ten percent (10%) interest; 2) purchasing and saving at least twenty-five thousand dollars ($25,000) in Credit Union shares; and 3) acquiring a diversified portfolio totaling at least five thousand dollars ($5000). Also, it is required that: 1) the pre-game budget loan has been repaid to the Credit Union with ten percent (10%) interest; and 2) and the adjusted market value of each team member's assets, in the aggregate, is at least fifteen thousand dollars ($15000). If the adjusted market value falls below the goal set by the team, the team has not won.

To determine the adjusted market value of the assets, the Boss shuffles a “Stock Exchange” set of cards, and selects a card from the top of the set to reveal the present market value of the assets.

In the third embodiment of the present invention, each player and/or team predicts, exactly or within a predetermined amount, for example: 1) what his/their holdings will be at the end of the game, for example, how much money, Credit Union shares, and/or retirement assets he will have; 2) how much over or under a predetermined budget he/they will be at the end of the game after the debts have been paid with interest; and/or 3) the number of players who will have retired before a predetermined amount of time expires.

The game is complete when a player or team has been successful at traveling from school to home after: 1) repaying all Credit Union debts, if any, at ten percent (10%) interest; purchasing and saving at least twenty-five thousand dollars ($25,000) in Credit Union shares; and 3) acquiring a diversified portfolio totaling at least five thousand dollars ($5000). However, a player or team is considered successful and thus, a winner, when the player or team has at least met the predictions established prior to the player or team members beginning travel around the path.

In another exemplary embodiment of the present invention, a player or team is considered successful and thus, a winner, when the player or team has come the closest to the predictions established prior to the player or team members beginning travel around the path.

In a fourth embodiment of the present invention, the players are playing against the securities market according to a market value determinator 23, for example a set of “Stock Exchange” cards. Prior to starting the game, the team assesses its budget requirements according to: 1) the expected receipts and payouts of money as team members travel around the path 14; and 2) the requirement to repay all Credit Union loans with ten percent (10%) interest. In accordance with the expected budget requirements, the team determines an advance amount that it will receive from the Credit Union, in cash, to finance the journey of its team members, from job one to retirement, without running out of money.

In the fourth embodiment of the present invention, no additional cash loans are made once the game begins and the players have begun to move along the path 14. In order for the team to be successful, and to be considered a winning team, the team must not lose all of its money before all of the members retire.

However, when a game of the present invention is played in accordance with the fourth embodiment of the present invention, the Boss does not utilize the asset type selector 20, when a team member lands on an “Open Season You May Purchase Retirement Security” space, to determine the category of assets a player is entitled to purchase. Instead, the Boss and/or one or more team members who have been delegated the responsibility of deciding which securities to acquire, choose a retirement security to purchase from any asset category based on his/their prediction of what the market value of the investment assets will be following the retirement of the last team member.

The adjusted market value of each team member's investments is determined utilizing a market value determinator 23 in accordance with the present invention. After each player retires to the home section, he utilizes the market value determinator 23 to ascertain the value of his investments after he has retired.

In a fifth exemplary embodiment of the present invention, two or more teams compete against each other. At the same time, each team, utilizing its own board, competes against the timing device 80. When the time expires, according to the timing device 80, the teams compare their performance, which may be recorded on one or more evaluation reports 78, results to determine a winner. The standards for ascertaining a winner are whatever the teams agree upon before the games begin.

A game in accordance with the present invention may be played in accordance with any one embodiment of the invention, or any combination of embodiments of the invention. Further, it should also be understood that reference to a player may also refer to a team, depending upon which embodiment or combination of embodiments of the present invention establishes the rules of the game.

In addition, any component of the game, for example, markers, sets of cards, selector devices, educational determinators, asset pieces, and counting devices, may be represented in other forms that achieve the objective of the component. For example, an asset color category may be selected according to the roll of a colored die. Also, the shapes, colors, sizes, and form of the components may vary, along with the indicia on the various components. In addition the amounts of funds disbursed by the Credit Union or collected by the Credit Union may vary.

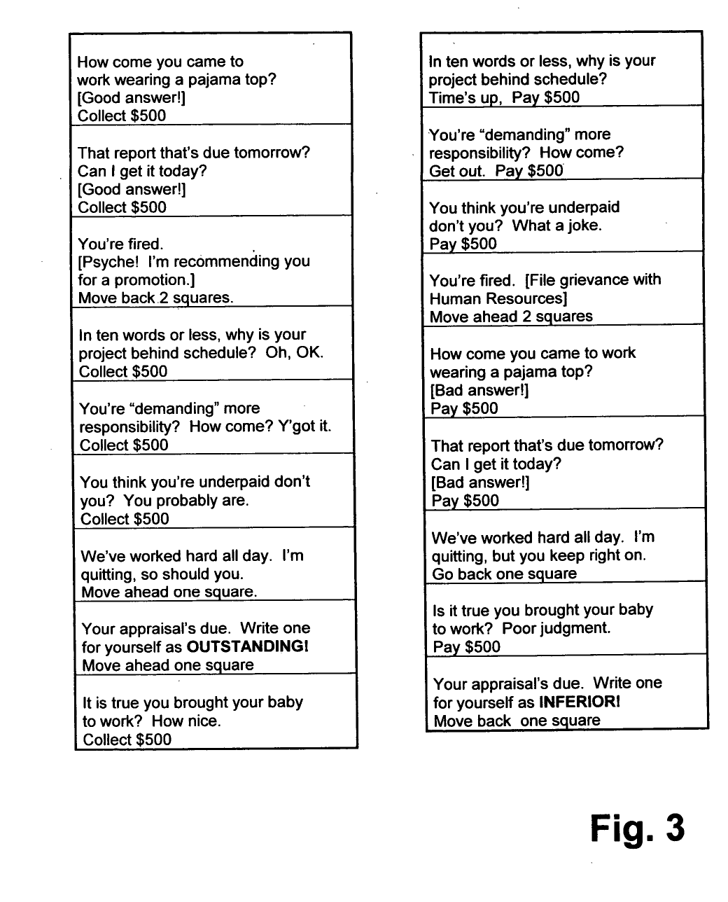

Shown in FIG. 3 are examples of instructional cards from a set of instructional cards 50, 52, 54 which, in the preferred embodiment of the present invention, are boss cards. Cards 156, 158, 160, 162, 164, 166, 168, 170, 172 represent “good/nice bosses”, while cards 174, 176, 178, 180, 182, 184, 186, 188, 190 represent “bad/not so nice” bosses. Cards 192, 194 represent “Big Boss” cards.

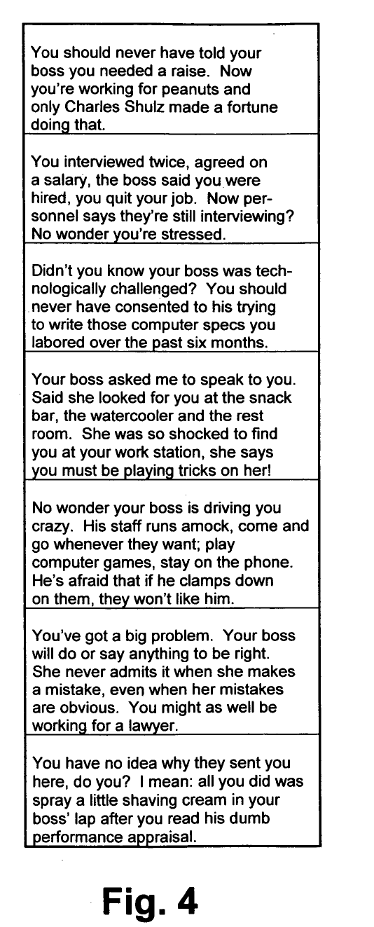

Shown in FIG. 4 are examples of “Professional Counseling” cards 200, 202, 204, 206, 208, 210, 212.

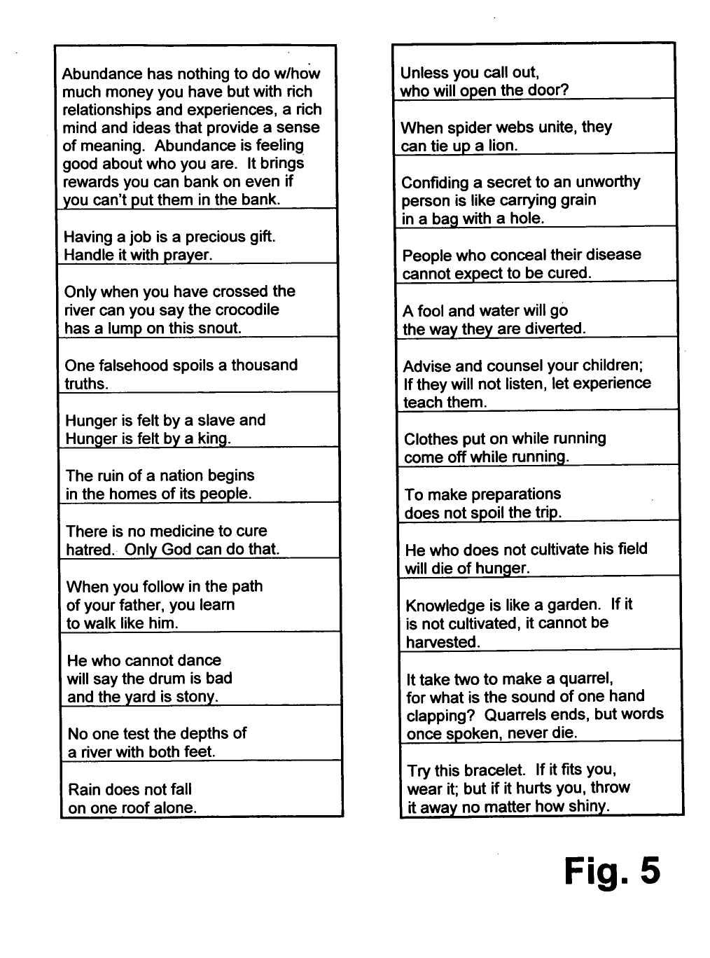

Shown in FIG. 5 are examples of “Spiritual Counseling” cards 214, 216, 218, 220, 222, 224, 226, 228, 230, 232, 234, 236, 238, 240, 242, 244, 246, 248, 250, 252, 254, 256, 258, 260.

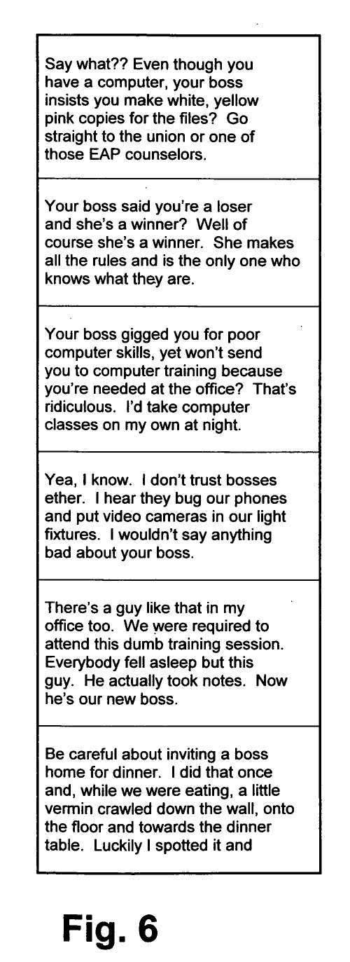

Shown in FIG. 6 are examples of “Grab Bag: Counsel from Coworkers at the Water Cooler” cards 262, 264, 266, 268, 270, 272.

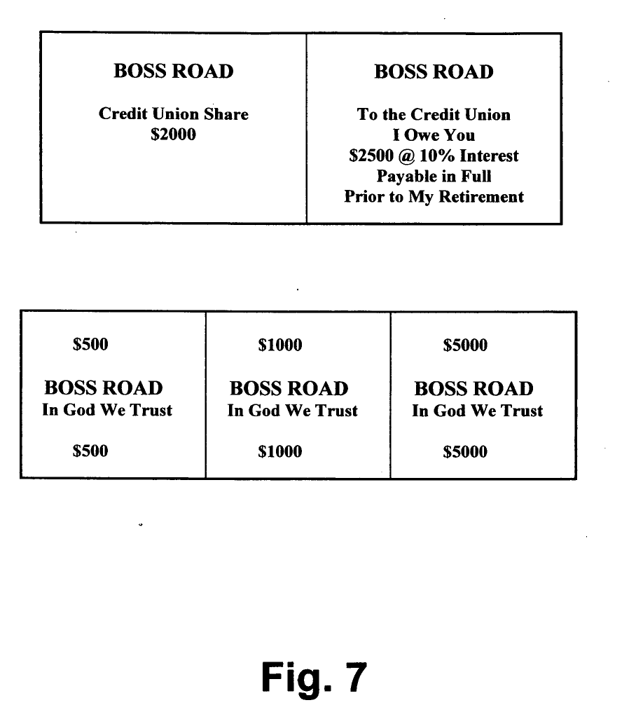

Shown in FIG. 7 is an asset piece in the form of a card representing a Credit Union share 274, asset pieces in the form of paper representing money, i.e., monetary assets 276, 278, 280, and a debt indicator, in the form of a card 282, representing a debt owed to the Credit Union.

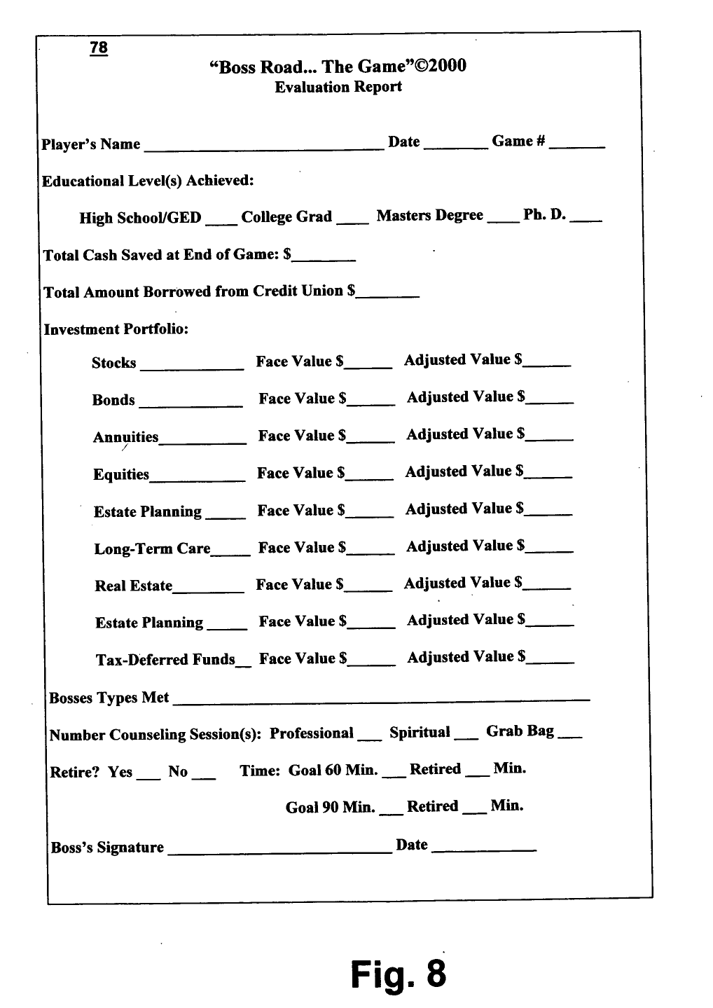

Shown in FIG. 8 is an evaluation report 78 in accordance with the present invention. An evaluation report 78 is utilized to maintain a record of a player's performance during each game played. An exemplary evaluation report/game card 78 includes space to record identifying information, track a player's assets, loans, savings, and debt repayment history. For example, the evaluation report shown in FIG. 8 includes, space to record: 1) a player's name, a date, and a game number; 2) an education level; 3) an amount borrowed form the financial institution; 4) number and types of investments, the face values of the investments, and adjusted market values of the investments; 5) the boss types met; 6) the number and types of counseling sessions; and 7) whether retirement was reached and in what amount of time and/or the game time length.

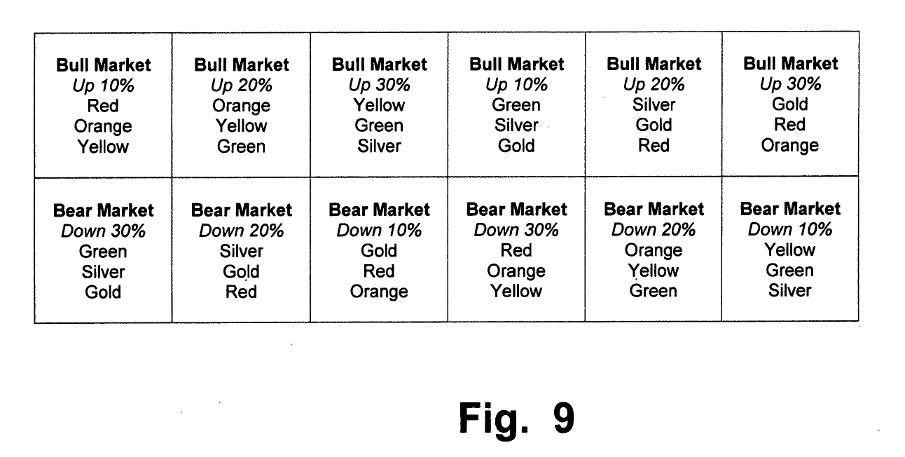

Shown in FIG. 9 are examples of “Stock Exchange” cards 284, 286, 288, 290, 292, 294 in accordance with the present invention.

Shown in FIG. 10 is a market value determinator 23 of an exemplary embodiment of the present invention that includes a first wheel 296 and a second wheel 298 coupled by a coupler 300. The first wheel 296 is coupled to the second wheel, such that when the first wheel 296 is spun, the second wheel 298 is stationary, and an adjusted value for each asset type space, for example, space 302, is determined according to an adjusted value amount space, for example, space 304. In another exemplary embodiment of the present invention, the first wheel 296 is coupled to the second wheel, such that when the second wheel 298 is spun, the first wheel 296 is stationary, and an adjusted value for each asset type space, for example, space 302, is determined according to an adjusted value amount space, for example, space 304.

Shown in FIG. 11 is a flow chart illustrating a method for teaching life skills that involves, for example, identifying a player to serve as a boss 306, identifying at least two players that follow instructions from the boss 308, for example, according to instructional cards, and following a course from school to retirement, i.e., home, while making investments 310, for example, to meet conditions for retirement, paying debts 312 from loans made, collecting bonuses 314, according to, for example, instructional cards, bonus spaces and/or an instructor, seeking counseling 316, for example, when instructed to according to a space on a board or from an instructor, and/or paying an amount of money to a financial institution 318 when required.

Moreover, while the system and method for teaching life skills has been described with reference to a board game, the system and method for teaching life skills may be embodied in a book, other tutorial medium, electronic medium, and/or computer-readable medium, and may be utilized, for example by a central processing unit (CPU).

Further, components of the system in accordance with the present invention, for example, the instructional cards, counseling cards, and markers may be directed to subject matter relating to a particular industry, for example a legal, business, corporate and/or medical industry.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A game for teaching life skills, comprising:
a boss type selector, comprising:
a first boss type space representing a first management style; and
a second boss type space representing a second management style;
a first set of instructional cards comprising instructions that correspond to the first boss space of the boss type selector; and
a second set of instructional cards differing from the first set of instructional cards and comprising instructions that correspond to the second boss space of the boss type selector.

2. The game of claim 1, wherein the boss type selector further comprises a pointer.

3. The game of claim 1, wherein the first set of instructional cards comprises at least one of a card that entitles a player of the game to a bonus amount of money and a card that requires the player to advance a number of spaces around a path of the game.

4. The game of claim 3, wherein a second set of instructional cards comprises at least one of a card that requires a player to pay an amount of money and a card that requires a player to move backwards a number of spaces around a path of the game.

5. The game of claim 1, wherein a first set of instructional cards comprises at least one of a card that grants a bonus amount of money and a card that requires moving ahead a number of spaces around the path, and wherein a second set of instructional cards comprises at least one of a card that requires payment of an amount of money and a card that requires moving backwards a number of spaces around the path of the game.

6. The game of claim 5, wherein the first boss type space is coded with a first color, and wherein the second boss space is coded with a second color that is different from the first color.

7. The game of claim 6, wherein the first set of instructional cards are coded with the first color and the second set of instructional cards are coded with the second color.

8. The game of claim 5, wherein the boss type selector comprises a pointer, and wherein the game further comprises a third set of instructional cards that correspond to a time when the pointer is positioned between the first boss type space and the second boss type space.

9. The game of claim 8, wherein the first set of instructional cards is coded red, the second set of instructional cards are coded blue, and the third set of instructional cards are coded white.

10. The game of claim 1, further comprising:
a planar surface, wherein the boss type selector is positioned on the planar surface and a path of spaces is printed on the planar surface; and
an asset type selector positioned of the planar surface, comprising:
an indicator;
a first asset type space representing a first asset type having a first value; and
a second asset type space representing a second asset type having a first value.

11. The game of claim 10, further comprising a first asset piece that corresponds to the first asset type space.

12. The game of claim 11, wherein the first asset piece is metallic in color.

13. The game of claim 11, further comprising a market value determinator that determines a second value for the first asset type.

14. The game of claim 13, wherein the path includes a start section and a finish section.

15. The game of claim 14, further comprising at least two markers, wherein the at least two markers represent players on the path.

16. The game of claim 15, further comprising a first set of counseling cards positioned on the planar surface.

17. The game of claim 16, further comprising a second set of counseling cards and a third set of counseling cards.

18. A game for teaching life skills, comprising:
a planar surface, comprising:
a start position;
a finish position; and
a path extending between said start position and said finish position, said path comprising:
a portion having spaces that form at least a part of words “Boss Road”.

19. A game for teaching life skills, comprising:
a boss type selecting means, comprising:
a first management style representation means; and
a second management style representation means;
a first instructional means corresponding to the first management style representation means; and
a second instructional means corresponding to the second management style representation means.

20. A method for teaching life skills, comprising:
identifying a player to serve as a boss; and
identifying at least two players that follow instructions from said boss, and follow a course from school to retirement that involves making investments, collecting bonuses, seeking counseling and paying amounts of money to a financial institution when required along the course.
